(19) United States
(12) Patent Application Publication
(10) Pub. No.: US 2016/0022091 A1
(43) Pub. Date: Jan. 28, 2016

(54) GRILL WITH ACTIVE PLATE LEVELING CONTROL

(71) Applicant: CARRIER COMMERCIAL REFRIGERATION, INC., Farmington, CT (US)

(72) Inventors: Otley D. Freymiller, Deerfield, WI (US); Ronald J. Glavan, Rockton, IL (US); Jeffrey L. Sands, Freeport, IL (US); Dennis J. Nelson, Rockford, IL (US)

(21) Appl. No.: 14/774,942

(22) PCT Filed: Mar. 14, 2014
(86) PCT No.: PCT/US2014/028577

§ 371 Date: Sep. 11, 2015

Related U.S. Application Data
(60) Provisional application No. 61/798,199, filed on Mar. 15, 2013.

(51) Int. Cl. A47J 37/06

(52) U.S. Cl. CPC A47J 37/0611

(57) ABSTRACT

A cooking apparatus includes a base including a lower heating plate, an upper heating unit including an upper heating plate and a mounting structure configured to support the upper heating unit, where the mounting structure includes a motor mounting part. The cooking apparatus includes two or more motors configured to control an angle of the upper heating plate with respect to at least two axes that cross each other by controlling a length of wire extending between the two or more motors and the upper heating plate. The cooking apparatus also includes at least one sensor configured to detect an angle of the upper heating plate and a controller configured to receive from the at least one sensor a signal corresponding to the angle of the upper heating plate and to automatically adjust the angle of the upper heating plate to correspond to a pre-defined plane.

### BACKGROUND OF THE INVENTION

Embodiments of the invention relate to plate leveling control and in particular to a grill or heating apparatus including position control assemblies to control a position of one or more heating plates.

Grills for cooking apply heat from a lower heating plate and from an upper heating plate to opposite sides of a food item to decrease cook times and to cook food evenly. However, differences in a height of food on the lower heating plate may result in the heating plates contacting the food at different times or at different pressures. In addition, if the upper plate is moved toward the lower plate with a hinge, the height of the food on the lower plate may result in the heating plates contacting the food at different times or at different pressures.

### BRIEF DESCRIPTION OF THE INVENTION

Embodiments of the present invention include a cooking apparatus including a base including a lower heating plate, an upper heating unit including an upper heating plate and a mounting structure configured to support the upper heating unit, where the mounting structure includes an upper heating unit support part. The cooking apparatus includes two or more rotating devices configured to control an angle of the upper heating plate with respect to at least two axes that cross each other by controlling a length of wire extending between the two or more rotating devices and the upper heating plate. The cooking apparatus also includes at least one sensor configured to detect an angle of the upper heating plate and a controller configured to receive from the at least one sensor a signal corresponding to the angle of the upper heating plate and to automatically adjust the angle of the upper heating plate to correspond to a pre-defined plane.

Embodiments of the invention further include a method of controlling a cooking apparatus including an upper heating plate configured to contact a first side of a food product to heat the first side of the food product and a lower heating plate configured to contact a second side of the food product opposite the first side to heat the second side of the food product. The method includes detecting, with at least one sensor, an angle of the upper heating plate with respect to a predefined plane. The method also includes controlling, with a controller and based on a signal from the sensor, at least two motors to change a span of cables extending from the at least two motors to the upper heating plate, to change an angle of the upper heating plate to correspond to the predefined plane, the upper heating plate being suspended from the at least two motors by the cables.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of a cooking apparatus according to one embodiment of the invention;

FIG. 2 is a perspective view of a portion of a cooking apparatus according to an embodiment of the invention; and

FIG. 3 is a flowchart illustrating a method according to an embodiment of the invention.

### DETAILED DESCRIPTION OF THE INVENTION

Conventional grilling apparatuses heat food from above and below, but may heat food unevenly due to different food heights, an angle of moving one heating plate towards another and other reasons. Embodiments of the invention relate to controlling the position of heating plates of a cooking device to supply heat evenly to food.

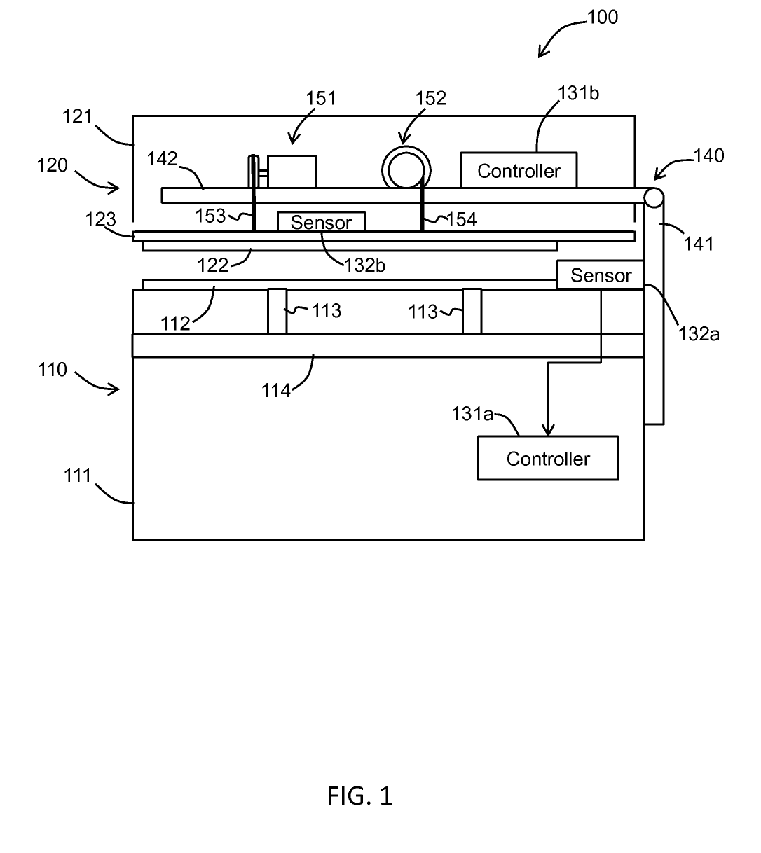

FIG. 1 illustrates a cooking apparatus 100 according to an embodiment of the invention. In one embodiment, the cooking apparatus 100 is a grilling apparatus for grilling food. The cooking apparatus 100 includes a base 110 including a housing 111 that rests on the ground, floor or another surface. The base 110 also includes a first heating plate 112, which may be referred to as a lower heating plate 112. The cooking apparatus 100 also includes an upper heating unit 120 including a housing 121 and an upper heating plate 122.

In FIG. 1, one configuration of a cooking apparatus 100 is illustrated including a single heating plate 112 on a housing 111 and a single upper heating unit 120. However, embodiments of the invention encompass any configuration of base 110, lower heating plate 112, upper heating unit 120 and upper heating plate 122, including multiple lower or upper heating plates or multiple upper heating units 120.

A mounting structure 140 mounts the upper heating unit 120 to a fixed surface, such as the housing 111 of the base 110 as illustrated in FIG. 1. Alternatively, the mounting structure 140 may be fixed to any other surface, such as a ceiling, a wall or the ground. In the embodiment illustrated in FIG. 1, the mounting structure 140 includes a mounting base 141 and a upper heating unit support part 142. In one embodiment, the mounting base 141 is moveable in a linear direction to linearly raise and lower the upper heating unit 120. In one embodiment, the upper heating unit support part 142 is rotatable with respect to the mounting base 141.

In embodiments of the invention, the upper heating unit 120 is suspended from the upper heating unit support part 142. In particular, the upper heating plate 122 is mounted to a lower surface 123 of the housing 121, and the lower surface 123 is suspended by wires or cables 153 and 154. The cables 153 and 154 are connected to rotating devices 151 and 152, such as spooling wheels connected to motors which are mounted to the upper heating unit support part 142. Since the upper heating plate 122 is suspended from the cables 153 and 154, the only pressure applied to an upper surface of a food product on the lower heating plate 112, is, at most, a pressure corresponding to a weight of the upper heating unit 120. The rotating devices 151 and 152 are configured to raise and lower the upper heating plate 122 based on the rotation of the rotating devices 151 and 152. As the rotating devices 151 and 152 rotate in one direction, the cables 153 and 154 are fed out from the rotating devices 151 and 152 and a part of the lower surface 123 connected to the cables 153 and 154 and a corresponding part of the upper heating plate 122 are lowered, tilting the upper heating plate 122. As the rotating devices 151 and 152 rotate in an opposite direction, the cables 153 and 154 are retrieved by the rotating devices 151 and 152 and the part of the lower surface 123 connected to the cables 153 and 154 and the corresponding part of the upper heating plate 122 are raised, tilting the upper heating plate 122.

The combination of the rotation of the first and second rotating devices 151 and 152 allows the upper heating plate 122 to be positioned in a wide variety of angles and orientations, such the upper heating plate 122 may tilted, around multiple crossing axes, at a positive angle and a negative angle relative to a horizontal plane based on the rotation of the first and second rotating devices 151 and 152.

In the embodiment illustrated in FIG. 1, the rotating devices 151 and 152 are spooling wheels connected to motors. The motors are mounted on the upper heating unit support part 142. However, embodiments of the invention encompass configurations in which the motors are mounting in locations other than on the upper heating unit support part 142. For example, in one embodiment, the rotating devices 151 and 152 are pulleys and the motors that reel in and release cable to and from the spooling wheels are located in the base 110. In such an embodiment, a series of pulleys may define the location of the cables 153 and 154, and the motors may be located outside a heating region to improve motor performance.

The cooking apparatus 100 further includes a controller 131a or a controller 131b for controlling the motors that reel in and release the cables 153 and 154. The controllers 131a and 131b include a processing circuit, programmable logic, memory and any other circuitry for receiving, analyzing processing and transmitting data. The cooking apparatus 100 also includes sensors 132a and 132b. While two sensors 132a and 132b are illustrated in FIG. 1, embodiments of the invention encompass any number of sensors, from one sensor to multiple sensors on one or both of the upper heating unit 120 and the base 110.

In one embodiment, the sensors 132a and 132b detect an angle or attitude of the upper heating unit 120 or the upper heating plate 122 and transmit a signal with data regarding the position of the upper heating unit 120 or the upper heating plate 122 to the controllers 131a or 132b. In addition, the sensor 132a may detect the angle or attitude of the base 110 or the lower heating plate 112 and may transmit a corresponding signal to the controllers 131a or 131b. The controllers 131a or 131b control the motors that control the rotating devices 151 and 152 based on the signals from the sensors 131a and 131b.

In the present specification and claims, the term “attitude” refers to the position of the upper heating plate 122, lower surface 123 or upper heating unit 120 as determined by the relationship between its axes (i.e. the angle of its length axis, the angle of its depth axis, and its height along a height axis) and a reference datum, such as a floor, the earth, the lower heating plate 112 or any other pre-defined reference datum.

Embodiments of the invention encompass any type of sensor capable of providing position data or other cooking data to the controllers 131a and 131b. Examples of sensors include inclinometers, accelerometers, pressure sensors, temperature sensors, acoustic sensors and optical sensors. In embodiments of the invention, the controllers 131a or 131b perform auto-leveling of the upper heating plate 122 with respect to the lower heating plate 112 by detecting position information of the upper heating plate 122 and controlling the motors that control the rotating devices 151 and 152 to level the upper heating plate 122 with respect to a predefined plane. For example, the pre-defined plane may correspond to a surface of the lower heating plate 112, so that the upper heating plate 122 is parallel to the lower heating plate 112. Alternatively, the predefined plane may be calculated based on food heights, so that the upper heating plate 122 is aligned to evenly contact food products of varying heights. According to yet another alternative, the predefined plane may be a horizontal plane. Embodiments of the invention encompass any predefined plane which may be stored as computer program data accessed by the controllers 131a or 131b or may be provided as user input by a user to control the controllers 131a and 131b.

In one embodiment, a food product is placed on the lower heating plate 112. One of the sensors 132a and 132b may detect the type of food product based on size, weight, image recognition or any other recognition process. Alternatively, a user may enter a control program selection indicating a type of food product that is placed on the lower heating plate 112. The controllers 131a or 131b control the motors that control the rotating devices 151 and 152 to position the upper heating unit 120 above the lower heating plate 112, such that a predetermined gap exists between the upper heating plate 122 and the lower heating plate 112 according to the type of food. The gap may be a constant gap over the entire area of the upper and lower heating plates 112 and 122 or the gap may vary according to different detected heights of the food product detected on the lower heating plate 112. In addition, the gap may vary over the course of cooking the food product. For example, the gap may be wider at the beginning of a cooking process and the controller 131a or 131b may control the mounting base 141 or one or both of the rotating devices 151 and 152 to incrementally decrease a size of the gap over time.

The cooking process may be completed by sensing that the food product is cooked or based on an elapsed cook time. The controllers 131a and 131b may then control the rotating devices 151 and 152 to lift the upper heating unit 120 away from the lower heating plate 112. If another food product is going to be cooked, the mounting structure 140 may be controlled to lift the upper heating unit 120 to an angle away from the lower heating plate 112 that is safe for an operator to apply food, such as between seventy-five and ninety degrees. The above gaps, positions and operations of the cooking apparatus 100 are provided only by way of example. Embodiments of the invention encompass controlling rotating devices 151 and 152 to move the upper heating unit 120 into any angle relative to the lower heating plate 112, or to have any gap relative to the lower heating plate 112.

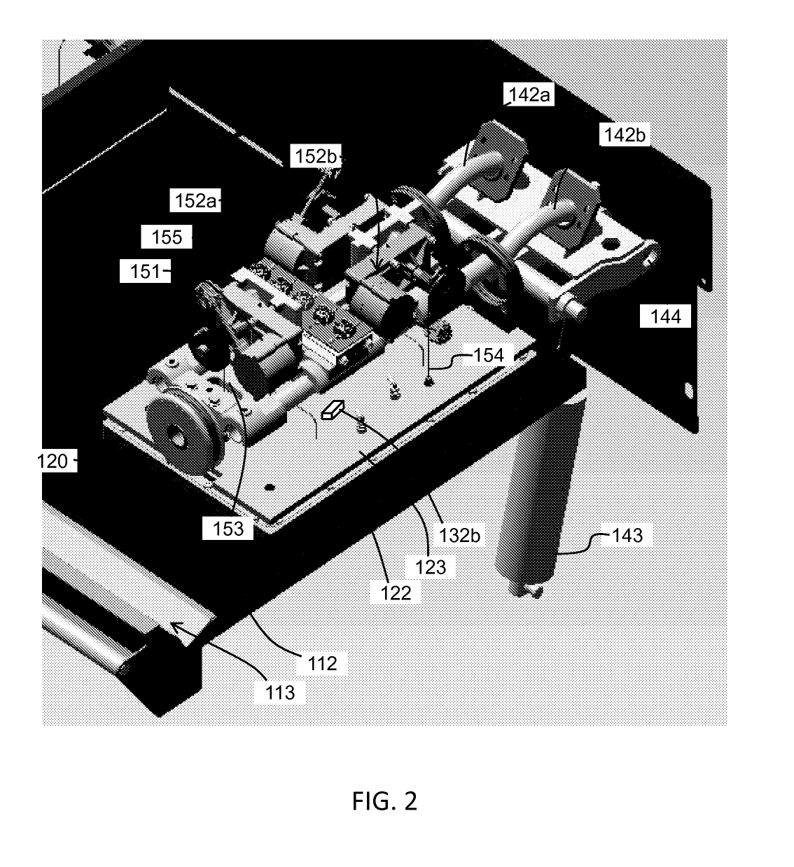

FIG. 2 illustrates a perspective view of a portion of a cooking apparatus 100 according to an embodiment of the invention. As illustrated in FIG. 2, the lower heating plate 112 may have a width corresponding to multiple upper heating units 120. A trough 113 may be formed at an end of the lower heating plate 112 to collect food by-products. The mounting structure 140 may include a linear actuator 143, mounting bars 142a and 142b and a rotation mount 144. Actuation of the linear actuator 143 may raise and lower the mounting bars 142a and 142b by rotating the mounting bars 142a and 142b with respect to the rotation mount 144. Although not illustrated in FIG. 2 for purposes of description, a bottom end of the linear actuator 143 is connected to a fixed surface, such as the base 111 or a support structure external to the base.

The mounting bars 142a and 142b correspond to the mounting part 142 of FIG. 1. Rotating devices 151, 152a and 152b are mounted on the mounting bars 142a and 142b, and cables 153 and 154 extend from the rotating devices 151 and 152b to the lower surface 123. In FIG. 2, the rotating devices 151, 152a and 152b include motors having spooling wheels that control a length of cable released from the spooling wheel to control a tilt of the upper heating plate 122. The wire extending from the rotating device 152b to the lower surface 123 is not shown in the perspective view of FIG. 2. While three rotating devices 151, 152a and 152b are illustrated in FIG. 2, embodiments of the invention encompass any number of motors controlling cables connected to the lower surface 123, including two motors, four motors or more. FIG. 2 also illustrates additional circuitry 155, which may include position control and sensing circuitry, heating control circuitry or any other circuitry to support operation of the upper heating unit 120.

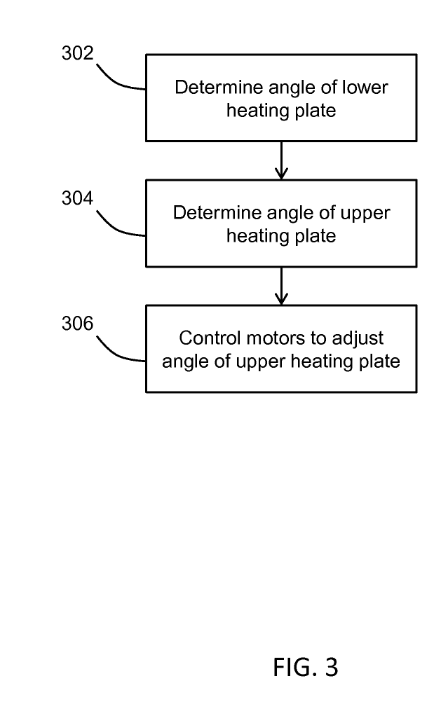

FIG. 3 illustrates a method according to an embodiment of the invention. In block 302, the angle or attitude of a lower heating plate of a cooking apparatus is determined. As discussed previously, the attitude is defined by the relationship between the axes of the lower heating plate with a reference point, such as the floor or ground. The attitude may be determined based on sensors, such as inclinometers and accelerometers.

In block 304, an angle or attitude of the upper heating plate is determined. In block 306, the attitude of the upper heating plate is adjusted to be parallel to the lower heating plate. The attitude of the upper heating plate may be adjusted by controlling a mounting structure and motors connected to the upper heating plate with cables to move the upper heating plate linearly in a height direction, rotationally around a depth axis and rotationally around a length axis.

In addition, while the method has been described to control an upper heating plate to be parallel to a lower heating plate, alternative relationships may be desired, such as aligning the upper heating plate at a predetermined angle with respect to the lower heating plate, according to a size or variety of food products resting on the lower heating plate.

According to embodiments of the invention, auto-leveling may be performed for a cooking apparatus having motors connected to an upper heating plate with cables. The attitude of the upper heating plate may be detected by sensors and the motors are controlled to align the upper heating plate with any desired plane, such as to be parallel to the lower heating plate or to have an angle corresponding to different food heights resting on the lower heating plate.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A cooking apparatus, comprising:
a base including a lower heating plate;
an upper heating unit including an upper heating plate;
a mounting structure configured to support the upper heating unit, the mounting structure including an upper heating unit support part;
two or more rotating devices configured to control an angle of the upper heating plate with respect to at least two axes that cross each other by controlling a length of wire extending between the two or more rotating devices and the upper heating plate;
at least one sensor configured to detect an angle of the upper heating plate; and
a controller configured to receive from the at least one sensor a signal corresponding to the angle of the upper heating plate and to automatically adjust the angle of the upper heating plate to correspond to a pre-defined plane.

2. The cooking apparatus of claim 1, wherein the controller is configured to control the at least two rotating devices to maintain the upper heating plate parallel to the lower heating plate.

3. The cooking apparatus of claim 2, wherein the at least one sensor includes a first sensor configured to determine an angle of the upper heating plate and a second sensor configured to determine an angle of the lower heating plate.

4. The cooking apparatus of claim 1, wherein the at least one sensor includes at least one of an inclinometer and an accelerometer.

5. The cooking apparatus of claim 1, wherein the mounting structure includes two metal bars extending into the upper heating unit, and
the two or more rotating devices are mounted on the two metal bars.

6. The cooking apparatus of claim 1, wherein the controller is located in the upper heating unit.

7. The cooking apparatus of claim 1, wherein the at least two rotating devices include three motors, configured to spool and unspool a respective wire connected to the upper heating plate to adjust an angle of the upper heating plate.

8. The cooking apparatus of claim 1, wherein the cooking apparatus is a grilling apparatus, the upper and lower heating plates are grills configured to cook opposite sides of a food product placed on the lower heating plate.

9. A method of controlling a cooking apparatus including an upper heating plate configured to contact a first side of a food product to heat the first side of the food product and a lower heating plate configured to contact a second side of the food product opposite the first side to heat the second side of the food product, the method comprising:
detecting, with at least one sensor, an angle of the upper heating plate with respect to a predefined plane;
controlling, with a controller and based on a signal from the sensor, at least two motors to change a span of cables extending from the at least two motors to the upper heating plate, to change an angle of the upper heating plate to correspond to the predefined plane, the upper heating plate being suspended from the at least two motors by the cables.

10. The method of claim 9, wherein determining the angle of the upper heating plate includes receiving a signal from one of an inclinometer and an accelerometer.

11. The method of claim 9, wherein the controller is configured to control the at least two motors to maintain the upper heating plate parallel to the lower heating plate.

12. The method of claim 9, wherein the controller is configured to control the at least two motors to position the upper heating plate at an angle corresponding to an upper surface of a food product positioned on the lower heating plate.

13. The method of claim 9, wherein the at least two motors are mounted on a motor mounting part of a mounting structure, and
the controller is configured to change the angle of the upper heating plate by controlling the span of cables extending from the at least two motors to the upper heating plate and controlling at least one linear actuator connected to the motor mounting part, a first end of the at least one linear actuator being fixed with respect to the ground and a second end of the linear actuator connected to the motor mounting part.
